(19) United States
(12) Patent Application Publication
(10) Pub. No.: US 2026/0138105 A1
(43) Pub. Date: May 21, 2026

(54) Systems, Methods and Apparatus for Gas Contamination Migration Management

(71) Applicant: Matheson Tri-Gas, Inc, Irving, TX (US)

(72) Inventors: Lawrence A. Rabellino, Atascadero, CA (US); Robert Torres, JR., Parker, CO (US); Gaku Tsuchibuchi, Boulder, CO (US)

(21) Appl. No.: 19/396,322

(22) Filed: Nov. 20, 2025

Related U.S. Application Data
(60) Provisional application No. 63/723,545, filed on Nov. 21, 2024.

(51) Int. Cl. B01J 3/02

(52) U.S. Cl. CPC B01J 3/02

(57) ABSTRACT

A system and method of preventing reverse migration of contaminant molecules includes an enclosure and a quantity of metal materials included within the enclosure. The quantity of metal materials includes multiple metal material surfaces. The metal material surfaces are conditioned to be attractive to at least a first portion of contaminant molecules. The first portion of contaminant molecules are adsorbed on the multiple metal material surfaces. The enclosure can be a canister with UHP gas flowing from an inlet to an outlet and the first portion of contaminant molecules randomly pass through the canister outlet into the canister.

### CROSS REFERENCE TO RELATED APPLICATIONS

This application claims priority from U.S. Provisional Patent Application No. 63/723,545 filed on Nov. 21, 2024 and entitled “Systems, Methods and Apparatus for Gas Contamination Migration Management,” which is incorporated herein by reference in its entirety for all purposes.

### FIELD OF THE DISCLOSURE

The present disclosure relates generally to ultra-high purity gas systems, and more particularly, to systems, methods and apparatus for gas contamination management.

### BACKGROUND

Ultra-high purity (UHP) gas includes gases with less than 0.1 parts per million (PPM) impurities. UHP gases are used in many chemical processes such as semiconductor manufacturing. UHP gas is used as a 99.99999 percent “pure” input to a chemical process. In semiconductor manufacturing processes UHP gas is input to a chemical process chamber where contaminants such as other gases and chemical process byproducts may be present. By way of example, a UHP gas may be injected into a plasma etch process chamber where a semiconductor wafer may be etched. The plasma etching process generates plasma byproducts including contaminant molecules of various sizes and various chemistries in the etching plasma. The UHP gas can be used as part of the chemical reactions occurring in the plasma and/or to purge these plasma byproducts from the plasma etch chamber.

Unfortunately, in conditions of zero gas flow or very low gas flow, some of the contaminant molecules can travel upstream into the UHP gas area of the system. “Back diffusion” and Brownian motion forces cause the contaminant molecules to randomly bounce around in the plasma etch chamber and into the UHP gas inlet to the plasma chamber. The contamination of the UHP gas area can then be carried into one or more adjacent process chambers that the UHP gas area is also supplying gas. In this manner, contaminant molecules can reverse migrate from the plasma etch chamber into the UHP gas areas and propagate to other chambers and processes that are also connected to the UHP gas areas. It is in this context that the following embodiments arise.

### SUMMARY

Broadly speaking, the present disclosure fills these needs by providing systems, methods and apparatus for gas contamination migration management. It should be appreciated that the present disclosure can be implemented in numerous ways, including as a process, an apparatus, a system, or a device. Several inventive embodiments of the present disclosure are described below.

One implementation provides a system and method of preventing gas contamination migration of molecules includes an enclosure and a quantity of metal materials included within the enclosure. The quantity of metal materials includes multiple metal material surfaces. The collisions between the surfaces and contaminant molecules decrease the kinetic energy of the contaminant molecules. The metal material surfaces are conditioned to be attractive to at least a first portion of contaminant molecules. The first portion of contaminant molecules are adsorbed on the multiple metal material surfaces. The enclosure can be a canister with UHP gas flowing from an inlet to an outlet and the first portion of contaminant molecules randomly pass through the canister outlet into the canister.

In another implementation, the enclosure is a perforated container and the perforated container is placed within a point of use such as semiconductor process chamber or transfer chamber. A second portion of contaminant molecules are adsorbed on the multiple metal material surfaces within the perforated container. The second portion of contaminant molecules are prevented from contaminating an item in the process chamber and/or a transfer chamber.

Yet another implementation provides a quantity of metal materials within an enclosure, the quantity metal materials including multiple metal material surfaces. The metal material surfaces being attractive to a plurality of contaminant molecules. At least a first portion of the contaminant molecules are adsorbed on the metal material surfaces.

Other aspects and advantages of the disclosure will become apparent from the following detailed description, taken in conjunction with the accompanying drawings, illustrating by way of example the principles of the disclosure.

### BRIEF DESCRIPTION OF THE DRAWINGS

The present disclosure will be readily understood by the following detailed description in conjunction with the accompanying drawings.

FIG. 1A is a side cross sectional view of a reverse contamination protection device for capturing contaminants in an upstream, reverse migration direction, for implementing embodiments of the present disclosure.

FIG. 1B is an inlet end view of the reverse contamination protection device for capturing contaminants in an upstream, reverse migration, for implementing embodiments of the present disclosure. FIG. 1C is a side cross sectional view of a reverse contamination protection device for capturing contaminants in an upstream, reverse migration direction, for implementing embodiments of the present disclosure.

FIG. 2 is schematic of the reverse contamination protection device in a bake out system, for implementing embodiments of the present disclosure.

FIG. 3 is schematic of the reverse contamination protection device in a UHP system, for implementing embodiments of the present disclosure.

FIG. 4 is a detailed view of the process chamber, for implementing embodiments of the present disclosure.

FIG. 5 is a flowchart diagram that illustrates the method operations performed in preventing contaminants from reverse migration into the UHP gas area, for implementing embodiments of the present disclosure.

FIG. 6A is schematic of the reverse contamination protection device in a UHP system, for implementing embodiments of the present disclosure.

FIG. 6B is schematic of one or more reverse contamination protection devices in a UHP system, for implementing embodiments of the present disclosure.

FIG. 7A is an end view schematic of an optical module, for implementing embodiments of the present disclosure.

FIG. 7B is a cross-sectional schematic of the optical module, for implementing embodiments of the present disclosure.

FIG. 8A is an end view schematic of an optical module including a Reverse Contamination Protection (RCP), for implementing embodiments of the present disclosure.

FIG. 8B is a cross-sectional schematic of the optical module RCP, for implementing embodiments of the present disclosure

### DETAILED DESCRIPTION

Several exemplary embodiments for systems, methods and apparatus for reverse gas migration management will now be described. It will be apparent to those skilled in the art that the present disclosure may be practiced without some or all of the specific details set forth herein.

One implementation of preventing reverse migration of contaminants from contaminating the UHP gas area includes a cannister coupled between the UHP gas area and a point of use, such as a process chamber. An inlet to the cannister is coupled to an ultra-high purity (UHP) gas supply. An outlet of the cannister is coupled to a point of use such as a process chamber or a flow controller or a pressure transducer or other device. The cannister is filled with a quantity of metal material that has a relatively rough surface roughness compared to the typical surface roughness for a UHP system. “Surface roughness Ra” refers to the average roughness, a measurement of a surface's microscopic peaks and valleys. Ra is calculated as the arithmetic average of the absolute deviations of the surface profile from its mean line. A lower Ra value indicates a smoother surface, while a higher value indicates a rougher one, measured in micrometers (μm) or microinches (μin). UHP systems generally specify surface roughness of 10 Ra or less. The metal material would be a surface roughness of greater than 1000 Ra. For reference, a 10 Ra roughness in stainless steel surface would appear to be as shiny as a mirror. A 1000 Ra roughness on a stainless steel surface would be a dull, matt finish with no shine. In one implementation, the metal material includes metal “wool” that includes many metal strands that are intertwined. The metal wool can include 316 SSL wool having a surface roughness of between about 100 Ra and about 1000 Ra.

The contaminant molecules can include high polarity molecules such as molecules with a high dipole moment, or hydrogen bonding, or weak Van der Waal forces and mechanisms of physisorption. Physisorption is a bond between two molecules that is due to a weak attraction similar to an attraction from a static electric surface. High polarity molecules can include water, toluene, ammonia, and others. The high polarity molecules stick to each other and will stick to high surface areas. The amount of surface area substantially determines a likelihood that a molecule will stick to the surface. The larger surface area (inside the canister of material), the greater likelihood that the molecule will be sorbed. Rough surfaces have much more surface area than a 10 Ra electropolished surface for the same projected area. As contaminant molecules enter the cannister in a reverse migration into the outlet, the contaminants will be adsorbed on the relatively rough surfaces of the metal material inside the cannister. The adsorption of the contaminant molecules prevents the contaminant molecules from reverse migrating further into the cannister to the cannister inlet and to the UHP gas supply coupled to the cannister inlet.

The random bouncing of the contaminant molecules results in the contaminants impacting the surfaces of the metal material inside the cannister. In the instance of the metal material inside the cannister including metal wool, the multitude of intertwined strands of the metal wool provide a complex path between the cannister outlet and the cannister inlet, as a result, the contaminant molecules are unlikely to successfully pass through the cannister and are much more likely to impact and stick to the surfaces of the metal wool.

In another implementation, the contaminant adsorbing action of the metal material can be used inside a process chamber while not fully filling the chamber. For example, one or more perforated metal containers can be placed inside the process chamber. The perforated metal containers can be filed with a relatively rough surface metal, such as a metal wool, as described above. As contaminant molecules bounce around inside the process chamber, the contaminants can impact the surfaces of the relatively rough surface metal, inside the perforated metal containers and stick to the relatively rough surface metal.

Before being deployed in the cannister or the perforated metal containers, the metal material will be cleaned and dried, as described in more detail below. The cleaned and dried surface of the metal material will also attract the contaminant molecules.

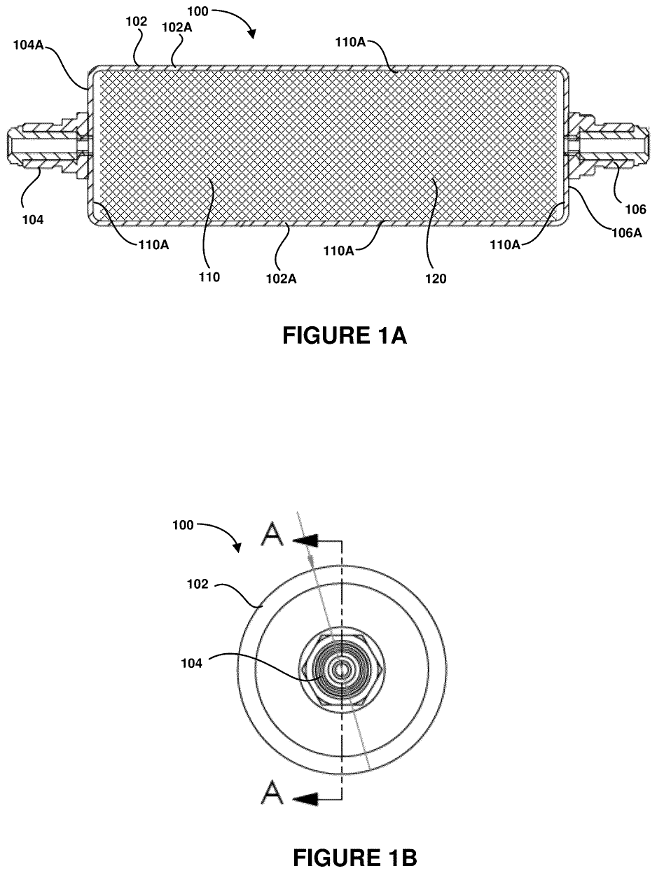

FIG. 1A is a side cross sectional view of a reverse contamination protection device 100 for capturing contaminants in an upstream, reverse migration direction, for implementing embodiments of the present disclosure. FIG. 1B is an inlet end view of the reverse contamination protection device 100 for capturing contaminants in an upstream, reverse migration, for implementing embodiments of the present disclosure. The reverse contamination protection device includes a canister body 102, an inlet 104 and an outlet 106. The canister body 102 includes end caps 104A, 106A and canister sidewall 102A which define an inner volume 110.

Inner surfaces 110A of the inner volume 110 are a passivated, standard mill surface finish which can be from 250 Ra to 1000 Ra to retain the surface roughness and cleanliness. The quantity of metal material 120 can also be cleaned and dried.

Typically, the cleaning and drying process is referred to as a “baking out” process.

The inner volume 110 is packed with a first quantity of metal material 120. The metal material 120 can include 316 stainless steel (SSL) wool and one or more other materials, as described herein. The metal wool and other materials described herein, have relatively rough surfaces.

FIG. 1C is a side cross sectional view of a reverse contamination protection device 100′ for capturing contaminants in an upstream, reverse migration direction, for implementing embodiments of the present disclosure. The reverse contamination protection device 110′ includes a first quantity of metal material 120A, a second quantity of metal material 120B and a third quantity of packed material 130C disposed between the first and second quantities of metal materials. Inner surfaces 110C of the inner volume are mill finish and passivated to retain the surface roughness and cleanliness. The first quantity of metal material 120A, the second quantity of metal material 120B and the third quantity of packed material 130C can also be cleaned and dried in a bake out process. In at least one implementation, the third quantity of packed material 130C is different from materials 120A, 120B and not limited to metal or metal oxide.

The inner volume 110 can be packed with the first quantity of metal material 120A, the third quantity of material 130C and the second quantity of material 120B. The inner volume 110 can be sandwich structure of 120A-130C-120B. The third quantity of material 130C can include metal, metal oxide, activated carbon pellets, polymers, and molecular sieves.

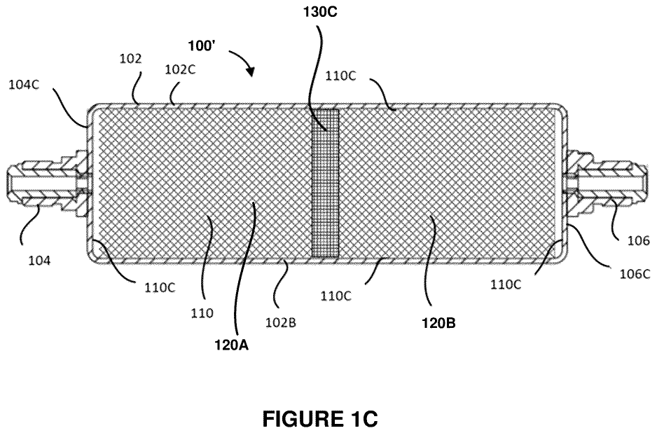

FIG. 2 is schematic of the reverse contamination protection device 100 in a bake out system 200, for implementing embodiments of the present disclosure.

During the bake out process, a heater 204 heats the inner surface 110A to a desired temperature, typically greater than about 300 degrees C, however, it should be understood that the bake out process can be between 50 and 500 degrees C. A UHP purge gas 206 is delivered from a UHP gas purge gas source 202. The UHP purge gas can be any suitable gas such as nitrogen or argon or other suitable UHP gas. The UHP purge gas is passed through the inlet 104, and flows into the inner volume 110. The inner volume and inner surfaces 110A are heated and purged for a sufficient time, however, it could be understood that the bake out time is a function of material and volume of the reverse contamination protection device and testing the effluent stream during the bake out process. Heating the inner surface 110A can include heating the UHP purge gas 206 which then heats the reverse contamination protection device and the inner surfaces. The bake out process causes contaminants such as water and other contaminant molecules that may be present on the inner surfaces 110A and surfaces of the materials within the inner volume (e.g., quantities of materials 120, 120A, 102B, 130C) to be released from the inner surfaces and any other surfaces inside the inner volume and into the flow of UHP purge gas. The combination 206A of UHP purge gas and contaminant molecules is transported out the outlet 106, into a suitable outlet device 210.

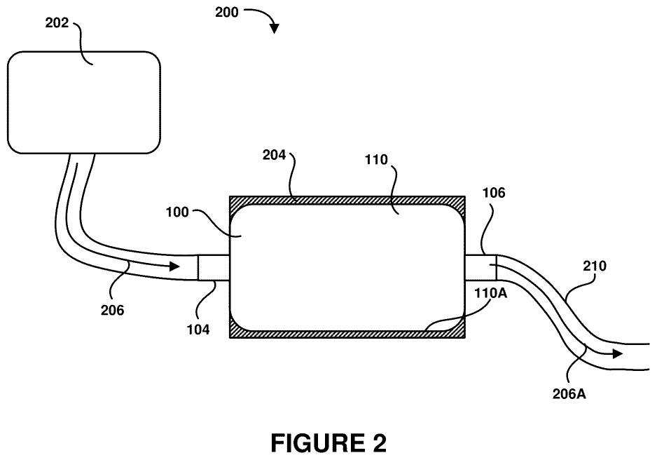

FIG. 3 is schematic of the reverse contamination protection device 100 in a UHP system 300, for implementing embodiments of the present disclosure. The UHP system 300 includes a UHP gas system environment 302 coupled to the inlet 104 of the reverse contamination protection device 100. The reverse contamination protection device outlet 106 is coupled to a point of use 304, such as a semiconductor process chamber. The semiconductor process chamber can also optionally include one or more perforated metal containers 310. The perforated containers include a perforated container wall 312 with multiple perforations 310A. The perforated containers 310 are filled with a fourth quantity of metal material 320A and a fifth quantity of metal material 320B.

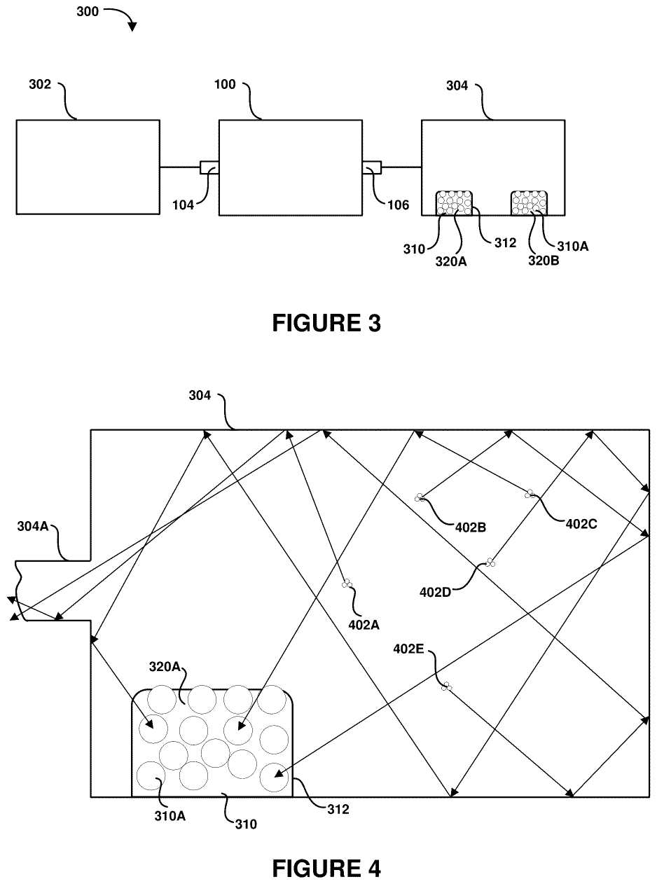

FIG. 4 is a more detailed view of the process chamber 304, for implementing embodiments of the present disclosure. Multiple contaminant molecules 402A-E bounce around inside the process chamber along the corresponding illustrated paths. Eventually, contaminant molecules 402A and 402E bounce in reverse migration direction, out the inlet 304A of the chamber and into the adjacent reverse contamination protection device 100, shown in FIG. 3. Contaminant molecules 402B, 402C and 402D bounce around inside the process chamber until the contaminant molecules pass through one of the perforations 310A of the container 310 and are adsorbed on the surface of the metal material 320A inside the container.

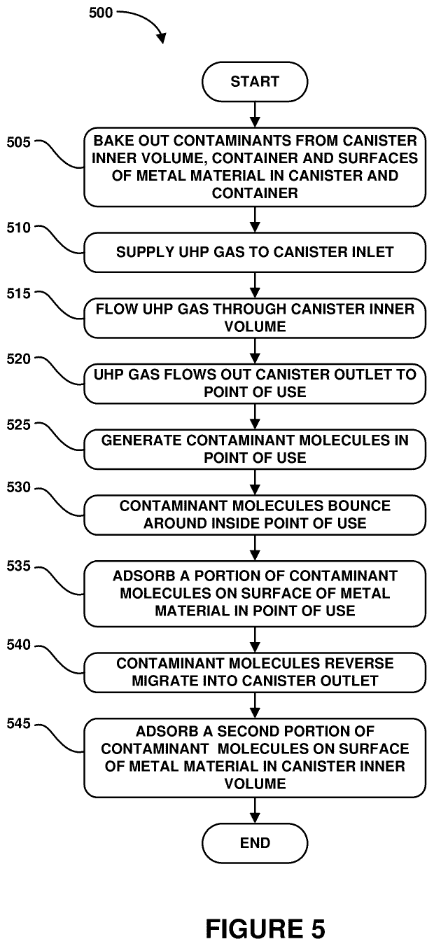

FIG. 5 is a flowchart diagram 500 that illustrates the method operations performed in preventing contaminants from reverse migration into the UHP gas area, for implementing embodiments of the present disclosure. The operations illustrated herein are by way of example, as it should be understood that some operations may have sub-operations and in other instances, certain operations described herein may not be included in the illustrated operations. With this in mind, the method and operations 500 will now be described.

In an operation 505, the reverse contamination protection device 100, container 304 and metal material 120 contained therein are cleaned and dried in a bakeout process as described above. The bakeout process removes contaminants from the inner surfaces of the reverse contamination protection device, and surfaces of the container and metal material.

In an operation 510, a UHP gas is supplied to the canister inlet 104. The UHP gas is supplied from a UHP gas source coupled to the canister inlet. The UHP gas flows through the inner volume 110 of the reverse contamination protection device and through the metal material 120 contained within the canister inner volume, in an operation 515.

In an operation 520, the UHP gas flows though the canister outlet 106 to the point of use. As described above, the point of use can be any suitable point of use such as a process chamber, a transfer chamber, a storage chamber, a purged chamber, a flow controller or any other device or chamber coupled to the canister outlet.

In an operation 525, contaminant molecules are generated inside the point of use. The contaminant molecules can already exist inside the point of use or can be generated by whatever process is occurring in the point of use, or any other source such as a source further downstream from the point of use.

In an operation 530, the contaminant molecules bounce around inside the point of use. Eventually, in an optional operation 535, at least some of the contaminant molecules adsorb on the surface of the metal material 120A inside the containers 310 included inside the point of use. Alternatively, or additionally, at least a portion of the contaminant molecules bounce around and into the canister outlet and into the canister inner volume 110, in an operation 540. The portion of the contaminant molecules in the inner volume adsorb on the surface of the metal material 120 inside the canister inner volume, in an operation 545.

In at least one implementation, a UHP gas flow of about 250 standard cubic centimeters per minute (sccm) of 99.9999% pure nitrogen gas flows into the RCP 100 at a pressure of about 1 psig. The UHP gas flow is doped with moisture and benzene at varying concentrations. The RCP demonstrate removal of both moisture and an organic compound, benzene, as described as follows. With inlet moisture at 90 ppb concentration, the RCP has a removal capacity of 0.026 L/L (liters of moisture at Standard Temperature and Pressure/liters of volume of the RCP purification media. With moisture at 5.4 ppm concentration, the RCP capacity increases to 0.23 L/L. it is expected that an adsorbant based material will have increased capacity with the increase in inlet contamination levels (ref Langmuir Isotherms). With moisture at 708 ppm concentration, the RCP has a capacity of 3.84 L/L. An exemplary organic test was performed with benzene at a 5 ppb concentration and the RCP has a capacity of 0.000038 L/L. While this may not be a substantial value, it is non-zero and is the basis for a claim of organic removal, in addition to moisture.

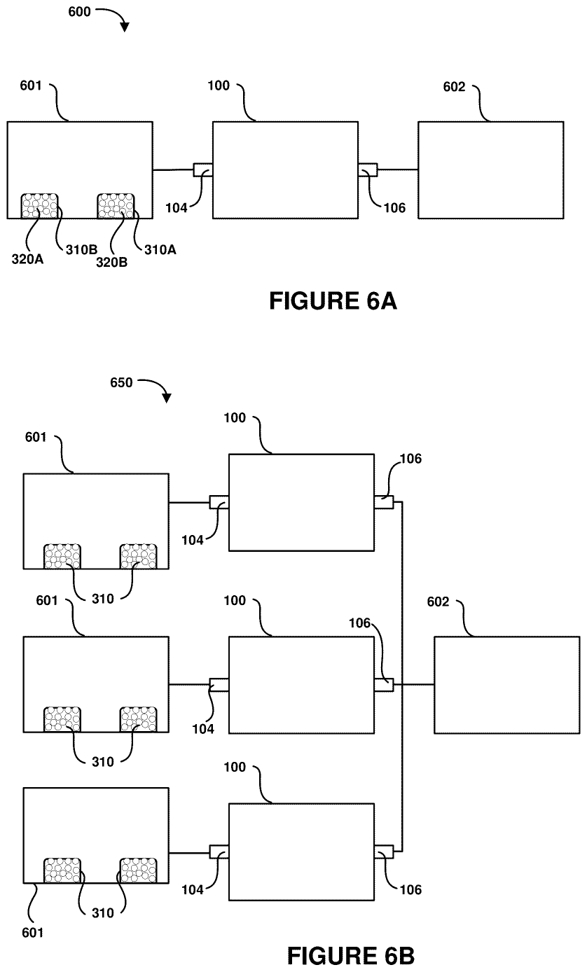

FIG. 6A is schematic of the reverse contamination protection device (RCP) 100 in a UHP system 600, for implementing embodiments of the present disclosure. The UHP system 600 includes a semiconductor process chamber 601 coupled to the inlet 104 of the reverse contamination protection device 100. The reverse contamination protection device outlet 106 is coupled to a process exhaust such as a vacuum pump and process abatement system 602. The reverse contamination protection device prevents reverse contamination migration from the pump and into the process abatement system 602 and into the process chamber 601. The process abatement system 602 can be a toxic, flammable, corrosive or other hazardous gas management system.

The semiconductor process chamber can also optionally include one or more perforated metal containers 310, 310A. The perforated containers 310, 310A are filled with the respective fourth quantity of metal material 320A and fifth quantity of metal material 320B.

FIG. 6B is schematic of one or more reverse contamination protection devices 100 in a UHP system 650, for implementing embodiments of the present disclosure. The UHP system 650 includes two or more parallel process chambers 601 with or without the perforated containers 310, and a pump and/or process abatement system 602.

In one implementation, the reverse contamination protection device can protect any surface that is sensitive to one or more specific, ambient, gas phase contamination. Note that the use of “ambient” can include outdoor conditions, indoor conditions, the conditions inside of an enclosure, such as inside a laser chamber or a stepper or even conditions inside a shipping container. Ambient air contains primarily nitrogen and oxygen. Ambient air also includes water vapor and trace levels of many different organic compounds and inorganic compounds that can damage sensitive surfaces. Sometimes the sensitive surfaces can be damaged anytime the sensitive is exposed to contaminant molecules. Other times the sensitive surfaces may only be sensitive to the potential damage by the contaminant molecules while the sensitive surface is in use. By way of example, a laser optic is more susceptible to damage when a laser light is projected through the laser optic while the laser optic is also exposed to one or more organic and/or inorganic compounds and/or water vapor and combinations thereof.

Molecular compounds typically travel in the gas phase by two mechanisms, momentum flow and Brownian motion. An example of momentum flow can be seen by the Bernoulli definition of laminar or turbulent flow. In order to protect the surface from momentum flow, a correctly applied gas stream of Ultra High Purity (UHP) clean, dry air (CDA) or UHP nitrogen or other purge gas can be sufficient to purge the contaminant molecules and molecular compounds away from a sensitive surface being protected.

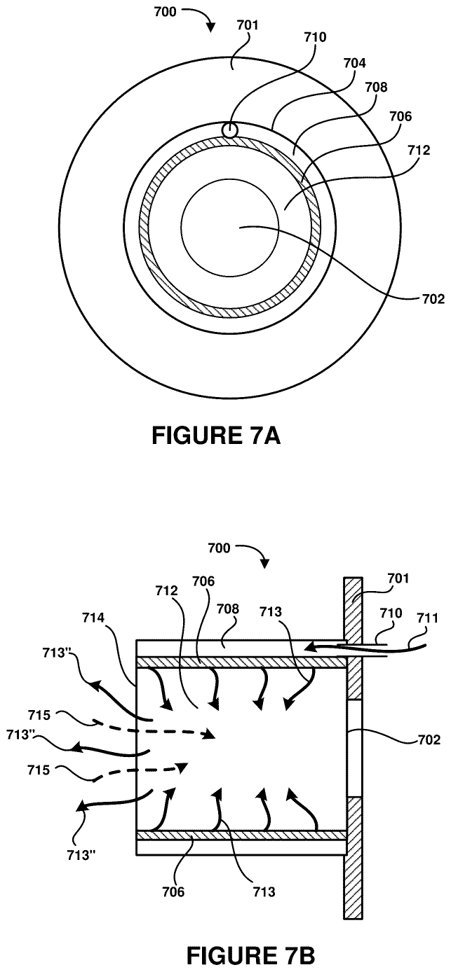

FIG. 7A is an end view schematic of an optical module 700, for implementing embodiments of the present disclosure. FIG. 7B is a cross-sectional schematic of the optical module 700, for implementing embodiments of the present disclosure. The optical module includes a critical surface 702 to be protected. The critical surface can be an optical window or a lens or other critical surface capable of passing light through the critical surface. The optical module also includes a containment wall 704 having a substantially cylindrical outer shape. A cylinder formed from a quantity of permeable media 706 is disposed within the containment wall to form an annular cavity 708 between the permeable media and an inner surface of the containment wall. The permeable media 706 can include a sintered metal.

A purge gas inlet 710 is coupled to a UHP purge gas source (not shown) and directs a quantity of UHP purge gas 711 into the annular cavity 708. The UHP purge gas can be UHP clean dry air (CDA) or UHP nitrogen or UHP argon or any other suitable purge gas. The annular cavity directs the purge gas to flow around the circumference of the annular cavity. The purge gas 713 passes through the permeable media, substantially equally around the circumference, into an inner volume 712. The purge gas 713″ then passes through an outlet 714 and out into the surrounding environment. A combination 713″ of purge gas and contaminant molecules and molecular compounds flow away from the critical surface 702, and out the outlet 714 using momentum flow, laminar or turbulent flow.

However, due to Brownian Motion movement, a portion 715 of contaminant molecules and molecular compounds may travel through the outlet 714 and into the inner volume 712 and potentially impinge on the critical surface 702. The Brownian Motion reverse flow can overcome the momentum flow, laminar or turbulent flow of the purge gas outward through the outlet 714. The high velocity and random nature of molecules demonstrated by Graham's Law can also contribute to the reverse flow into the inner volume 712. These contaminant molecules and molecular compounds can include but are not limited to organic compounds, inorganic compounds and water vapor and combinations thereof.

Example organic molecular compounds, such as toluene, can include other gas phase organic compounds which are typically found in low concentrations in ambient conditions. Organic compounds can cause photo contamination related damage to optics such as when a laser passes through the optics and interacts with the contaminant molecules and molecular compounds.

These organic compounds can be categorized by the number of carbon molecules. By way of example, toluene has a carbon atom count of 7. Toluene is often considered as a standard for measurement relating to management of gas phase organic contaminants because toluene is a hydrocarbon that outgases from many common compounds (fuel, lubricants, etc) and can be in the gas phase in ambient air.

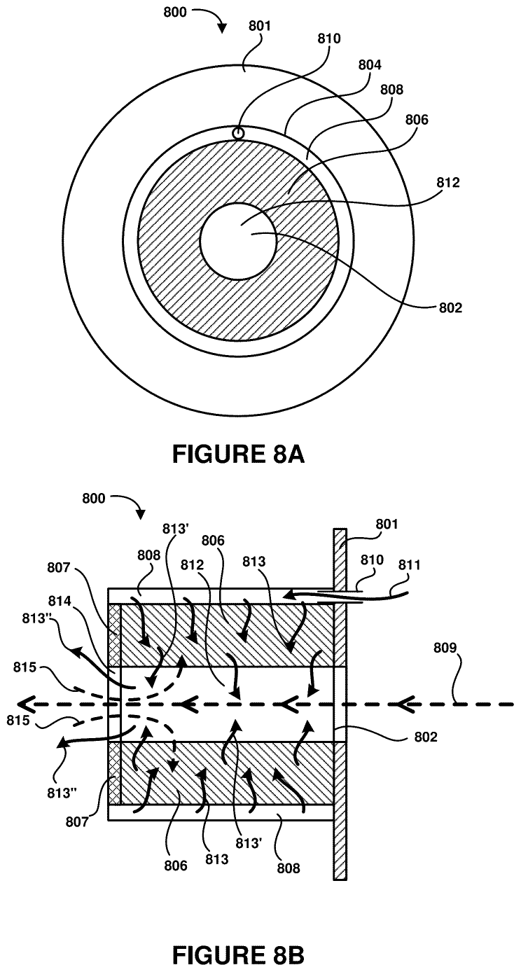

FIG. 8A is an end view schematic of an optical module 800 referred to as a “Reverse Contamination Protection” (RCP), which includes “Reverse Contamination Protection Technology” (RCPT), for implementing embodiments of the present disclosure. FIG. 8B is a cross-sectional schematic of the optical module 800 RCPT, for implementing embodiments of the present disclosure. The optical module 800 including the RCP, increases the protection for the critical surface 802 while also allowing the critical surface to function with an unobstructed optical path 809 to the outlet 814. The optical module 800 includes a containment wall 804 forming a cylinder having a first end sealed to a flange 801. A quantity of RCPT material 806 is formed as a cylinder and disposed within the containment wall, forming an annular cavity 808 between the containment wall and the RCPT material. A purge gas port 810 is coupled to the annular cavity and couples a purge gas source (not shown) to the annular cavity. The annular cavity distributes the purge gas around the circumference of the annular cavity so that the purge gas can enter an inner volume 812, substantially equally, from all directions. The cylindrical RCPT material 806 includes a solid end cap 807 to retain RCPT and assist in directing purge gas flow into the inner volume.

The RCPT provides a torturous path for molecules behaving in Brownian motion, while also providing surfaces that can sorb water vapor and other contaminant molecules and molecular compounds. The open, inner volume allow the optical path 809 for light to travel through the critical surface 802 and through the optical module and out the outlet.

Contaminant molecules and molecular compounds may back diffuse through the outlet and into the inner volume 812, however, the Brownian motion of such contaminant molecules and molecular compounds is very random and fast. The velocity and mean free path of each molecule is a different, random motion. By way of example, in a mixture of gases like toluene and air, the mean molecular speed of toluene is approximately 417 m/s, and its mean free path is on the order of tens of nanometers under standard atmospheric conditions. These values are calculated using principles from the kinetic theory of gases.

When the critical surface 802 is first exposed to air with the UHP gas purge flow present, and there is no toluene present in the inner volume 812. As time progresses, any toluene molecules in the surrounding atmosphere will begin to migrate to the outlet 814 due to the random motion of the toluene molecules and because there is no toluene present in the inner volume. This lack of toluene molecules in the inner volume acts to motivate toluene molecules into the inner volume due to the reduced partial pressure of toluene and the molecular behavior of molecules to always try to maintain a constant partial pressure. However, as the toluene molecules migrate through the outlet and into the inner volume, the RCPT 806 provides an alternate path. The random behavior of the molecules causes the molecules to move in all directions, without considering any momentum purge flow at this time, therefore, the toluene molecules entering the inner volume are likely to attempt to travel “into” the RCPT.

Once the molecules enter the RCPT, there is an equal likelihood that the molecules will go deeper into the RCPT or exit the surface of the RCPT. However, the RCPT is a high surface area, porous material and has the ability to sorb toluene and therefore there is a strong likelihood that toluene molecules entering the RCPT will remain captured within the RCPT. Similarly, water vapor and other contaminant molecules and molecular compounds will be sorbed by the RCPT.

When the momentum flow of the purge gas 811 is added, contaminant molecules are further discouraged from migrating upstream, through the outlet 814 and into the inner volume 812 and toward the critical surface 802. The purge gas flow 811 enters the purge gas inlet 810 and into the annular cavity 808. As the purge gas distributes around the circumference of the RCPT, and begins to flow into the RCPT. The purge gas 813′passes though many torturous paths though the RCPT to emerge into the inner volume. A combination 813″ of the purge gas and contaminant molecules and molecular compounds and continues to flow out the outlet.

Reverse contamination protection of the RCP can be used to separate a UHP area from a non-UHP area, with the intention of protecting the integrity of the UHP area. Examples can be found in installation of a relief valve, a pressure transducer, a pressure gauge or a vent valve that may not be as intrinsically clean as a UHP system. This embodiment of the RCP is the same cylinder with material inside but includes a flow orifice on each port at the interface between the UHP and non-UHP environments. The intention of the orifice is twofold. In the event that the RCP is used to protect a UHP system from a non-UHP relief device, the RCP needs to allow unrestricted flow, but depending upon the operating pressure, the surge can be tremendous and cause potential damage to the material in the RCP. Therefore, a flow restriction is included which does not violate the intention of a relief device but allows that relief device to be connected to a UHP system even though it is not a UHP component. By way of example, typical pressure relief valves require seat lubricant on the seat and seal to prevent stiction. The seat lubricant is not compatible with a UHP system as the seat lubricant can be a source of gas phase, contaminant molecules and molecular compounds. In addition, pressure measurement devices such as pressure transducers or pressure gauges often cannot be sufficiently cleaned to UHP requirements due to small cavities and passages contained within the pressure transducers or pressure gauges.

The RCP allows essentially a zero pressure drop path for gas flow from the UHP side to the non UHP side, allowing a pressure transducer or gauge to function as designed while also substantially eliminating the risk of reverse contamination. In this implementation, the RCP would be designed to have greater than 10× the free volume entrapped by the downstream device. The 10× volume ratio allows the RCP capture any reverse flow of contaminant molecules and molecular compounds if there is more pressure at the gauge and the pressure is vented on the UHP side. It should be understood that the Ideal Gas Laws provides that if there were two cubic centimeters (CCs) of free volume in the pressure gauge at six barg pressure, and this free volume was vented to atmosphere, there would now be 12 CCs of actual gas volume displaced that would be need to be managed by the RCP.

The RCPT is intrinsically non-particle generating and has zero pressure drop in these conditions of essentially static pressurization. In the instance of a pressure relief event, where the RCP is being used as a barrier, orifice would need to be appropriately sized to prevent the momentum flow from damaging the RCPT material inside.

It should be understood that terms such as “about”, “on the order of” and “approximately” can include +/−10-20% of the stated value as may be applicable to the quantity described. Although the foregoing disclosure has been described in some detail for purposes of clarity of understanding, it will be apparent that certain changes and modifications may be practiced within the scope of the appended claims.

Accordingly, the present embodiments are to be considered as illustrative and not restrictive, and the disclosure is not to be limited to the details given herein, but may be modified within the scope and equivalents of the appended claims.

1. A system for preventing reverse migration of contaminant molecules comprising:
an enclosure; and
a quantity of metal materials included within the enclosure, the quantity metal materials including a plurality of metal material surfaces, the plurality of metal material surfaces being attractive to a plurality of contaminant molecules.

2. The system of claim 1, wherein the enclosure is a reverse contamination protection device, wherein the reverse contamination protection device includes:
a canister body;
a canister inlet disposed on a first end of the canister body; and
a canister outlet disposed on a second end of the canister body, the second end being opposite from the first end.

3. The system of claim 2, wherein a UHP gas source is fluidly coupled to the canister inlet and a point of use is fluidly coupled to the canister outlet and wherein the plurality of contaminant molecules pass though the canister outlet from the point of use.

4. The system of claim 1, wherein the enclosure is a perforated container including:
a perforated container wall;
a plurality of perforations in the perforated container wall.

5. The system of claim 4, wherein the perforated container is disposed within a point of use.

6. The system of claim 1, wherein the quantity of metal materials includes a quantity of metal wool.

7. The system on claim 1, wherein the quantity of metal materials includes one or more of a stainless steel material, nickel, non-ferrous metals including titanium, Inconel, Hastelloy and alloys and combinations thereof.

8. The system on claim 1, wherein the quantity of metal materials includes:
a first quantity of a first metal material disposed in a first portion of the enclosure;
a second quantity of the first metal material disposed in a second portion of the enclosure; and
a quantity of a third material disposed between the first and second portions of the enclosure.

9. The system of claim 1, wherein the enclosure includes a mill quality surface finish between 5 ra and 1000 ra.

10. The system of claim 1, wherein the plurality of metal material surfaces having mill quality surface finish between 5 ra and 1000 ra.

11. The system of claim 1, wherein the enclosure is an optical module including:
a cylindrical containment wall;
a first end of the cylindrical containment wall being sealed to a flange;
wherein the quantity of metal materials includes a quantity of RCPT material formed in a cylinder, the quantity of RCPT material being disposed inside the cylindrical containment wall and forming an annular cavity between the quantity of RCPT material and an inner surface of the cylindrical containment wall, the quantity of RCPT material forms an inner volume;
a purge gas port coupling a UHP purge gas source to the annular cavity; and
a canister outlet disposed on a second end of the cylindrical containment wall, the second end being opposite from the first end, wherein the flange including a critical surface aligned with the inner volume and the canister outlet and defining an optical path passing through the critical surface, through the inner volume and through the canister outlet.

12. A method of preventing reverse migration of contaminant molecules comprising:
providing a quantity of metal materials within an enclosure, the quantity of metal materials including a plurality of metal material surfaces, the plurality of metal material surfaces being attractive to a plurality of contaminant molecules; and
adsorbing at least a first portion of the plurality of contaminant molecules on the plurality of metal material surfaces.

13. The method of claim 12, further comprising flowing a quantity of UHP gas through the enclosure, wherein the quantity of metal materials provide a near zero pressure drop to the UHP gas flowing through the enclosure.

14. The method of claim 13, wherein the quantity of metal materials are inert to the UHP gas.

15. The method of claim 13, wherein the quantity of metal materials do not generate any contaminant molecules.

16. The method of claim 13, wherein the quantity of metal materials includes a first portion of a first metal material and a second portion of a second metal material and further comprising heating at least the first portion of metal materials to a temperature less than an adsorption temperature of the contaminant molecules.

17. The method of claim 13, wherein the quantity of metal materials includes a first portion of a first metal material and a second portion of a second metal material and further comprising heating at least the first portion of metal materials to a temperature less than a chemical reaction temperature of the contaminant molecules.

18. A system for preventing reverse migration of contaminant molecules comprising:
a point of use chamber;
a perforated container disposed within an inner volume of the point of use chamber, the perforated container including a perforated container wall, the perforated container wall including a plurality of perforations; and
a quantity of metal materials included within the perforated container, the quantity metal materials including a plurality of metal material surfaces, the plurality of metal material surfaces being attractive to a plurality of contaminant molecules.
